(19) United States
(12) Patent Application Publication
(10) Pub. No.: US 2012/0191803 A1
(43) Pub. Date: Jul. 26, 2012

(54) DECOMMISSIONING FACTORED CODE

(75) Inventors: Kenneth Ray, Seattle, WA (US); Gennady Medvinsky, Redmond, WA (US); Vijay Gajjala, Sammamish, WA (US); Darko Kirovski, Kirkland, WA (US); Benjamin Livshits, Kirkland, WA (US)

(73) Assignee: MICROSOFT CORPORATION, Redmond, WA (US)

(21) Appl. No.: 13/013,534

(22) Filed: Jan. 25, 2011

(51) Int. Cl. G06F 15/16

(52) U.S. Cl. 709/217

(57) ABSTRACT

Various embodiments are disclosed that relate to decommissioning factored code of a program on a computing device. For example, one disclosed embodiment provides a method of operating a computing device. The method includes executing a program on the computing device, and while executing the program, identifying a remote location of a factored function via a code map, sending a call to the factored function and receiving a return response. The method further comprises, upon occurrence of a decommissioning event, receiving a copy of the factored function; and updating the code map with a location of the copy of the factored function.

### BACKGROUND

Computer programs for personal computers are prone to reverse engineering. For example, license enforcement code in such programs may be detected and disabled by editing a program's machine code. As a consequence, once a computer program hits the market, attackers may reverse engineer its protection mechanism and produce a new copy that appears functionally equivalent to the genuine copy, but with disabled anti-piracy enforcement.

### SUMMARY

Various embodiments are disclosed that relate to decommissioning factored code of a program on a computing device. For example, one disclosed embodiment provides a method of operating a computing device. The method comprises executing a program on the computing device, and while executing the program, identifying a remote location of a factored function via a code map, sending a call to the factored function and receiving a return response. The method further comprises, upon occurrence of a decommissioning event, receiving a copy of the factored function, and updating the code map with a location of the copy of the factored function.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an embodiment of an example of a use environment for a factored program.

FIG. 2 shows an embodiment of an example embodiment of a decommissioning event and subsequent decommissioning of factored code.

FIG. 3 shows an embodiment of a method of decommissioning factored code of a program.

FIG. 4 shows a block diagram depicting an embodiment of a computing device.

### DETAILED DESCRIPTION

Recent developments in anti-piracy technology have led to the development of split computational anti-piracy methods. Split computational methods involve partitioning, or factoring, a program into two or more pieces that are executed remotely or separately from one another. For example, in some implementations, a smaller, functionally important piece of a program is located on a server, while the remainder of the program is located on a client. The client executes the program up to a point where the control flow leads to the server partition. The client then may prepare the appropriate data as input and make a remote procedure call to the functionality present at the server. If the client copy of the program is authorized, the server executes the call and returns results to the client. On the other hand, if the client copy is not authorized or if the server detects tampering attempts, the server will refuse to execute the call or will execute the call differently than it would for authorized clients, thereby disrupting execution of the program on the client.

However, such split computational anti-piracy methods may increase run-time operational costs for the program. Thus, at some point during the lifetime of the factored program, it may be desirable to transfer the remotely executed piece of code so that it can run locally. Such downloading of a remotely executed piece of a factored program so that the remotely executed piece can run locally is referred to herein as “decommissioning.”

A factored program may be decommissioned after the occurrence of a predetermined threshold event, such as an event count threshold or a time threshold. Further, a factored program may be decommissioned at any time by a publisher. For example, once a publisher of a factored program has recovered profits expected from an initial investment, the publisher may desire to reduce nm-time operational costs of the factored program, as the value of the factored program following the recovery of profits may be lower than the operational costs associated with maintaining the program in factored form. Thus, at some point in the life of the factored program, e.g., after an opportunity width of a sales curve has passed or at any publisher-determined time, the factored program may be decommissioned to run partially or entirely from a client with no remote service dependencies. Any event, request, or other occurrence that triggers a decommissioning process is referred to herein as a “decommissioning event”

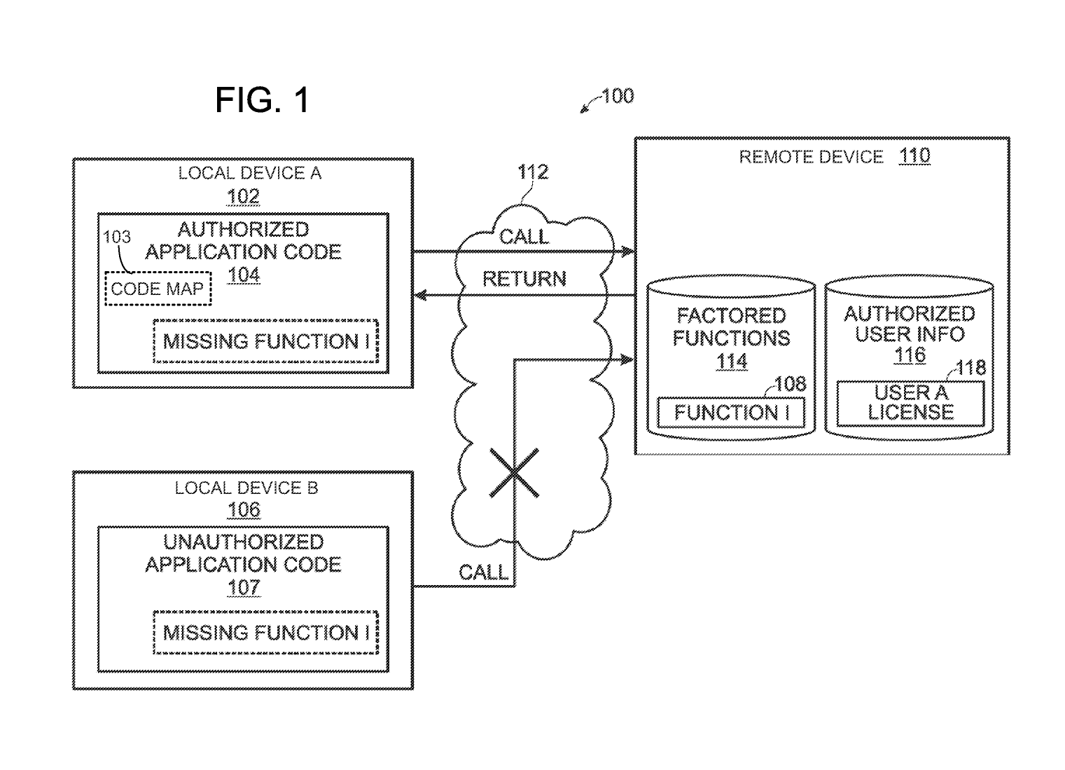

Accordingly, embodiments are disclosed that relate to decommissioning a factored program. Prior to discussing the decommissioning of a factored program, an embodiment of an example use environment is described with reference to FIG. 1. Use environment 100 comprises a first computing device A 102, on which an authorized copy of program code 104 is running, and a computing device B 106 on which an unauthorized copy 107 of the program code is running.

Both the authorized and unauthorized versions of the program code are missing one or more functions that instead reside on a remote computing device 110 that is accessible via network 112. It will be understood that the term “function” and the like as used herein to describe factored code may signify any code portion separated from the rest of a program. The missing function i may be selected for separation from the rest of the program code based upon various considerations, including but not limited to an importance of the use of function 108 to a satisfying user experience, a difficulty of inferring an operation of the function 108 from an input/output analysis, any economic and/or computing resource costs associated with the remote hosting of the function 108, and other such considerations. While the missing function i is depicted as being stored on a remote server system, it will be understood that the missing function may be stored on any suitable remote computing device. Further, it will be understood that the term “server” as utilized herein may refer to any such remote computing device that hosts one or more missing functions.

The program code may additionally include a code map 103. The code map indicates the location of the code to be run by the program. For example, the code map may be a library such as a manifest file or xml document which includes location information of the functions called by the program. As described below, the code map may be dynamically updated during decommissioning of a factored program so as to track the locations of the functions during the decommissioning process.

Remote computing device 110 comprises a factored function store 114 in which missing function i is stored, and also comprises an authorized user information store 116 in which information on authorized users may be stored. As an example, FIG. 1 depicts a “user A license” 118, corresponding to the user of computing device A 102, as being stored on remote computing device 110. In contrast, no license is stored for the unauthorized copy running on computing device B.

FIG. 1 also illustrates example communication between remote computing device 110 and clients A and B. As computing device A executes the program code, upon reaching a point in code at which it needs to utilize the missing function 108, computing device A calls the missing function 108 at the remote computing device 110 via network 112. Remote computing device 110 receives the call, determines that computing device A is running an authorized copy of the program code, and then executes the function and returns a result to computing device A. On the other hand, when computing device B calls the missing function 108, remote computing device 110 determines that computing device B is not running an authorized copy of the program code, and does not execute missing function 108 and return a result to computing device B. In this case, various different failure modes are possible.

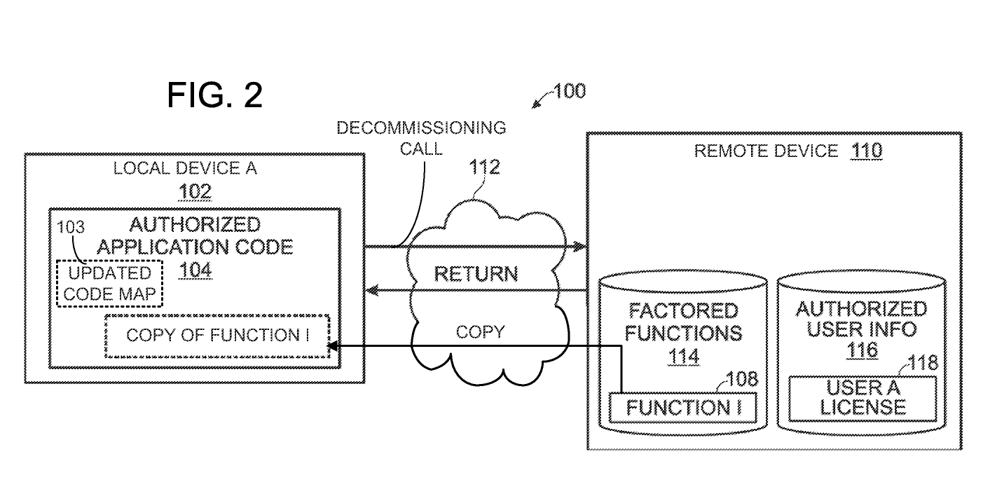

FIG. 2 shows an embodiment of an example decommissioning event, and a subsequent decommissioning of factored code wherein a copy of remotely-located function i is downloaded to computing device A so that function i may be executed locally. In the depicted embodiment, the depicted decommissioning event comprises a call to the missing function 108 that meets or exceeds a predetermined number of utilizations of the missing function, but it will be understood that any other suitable decommissioning event may trigger decommissioning. Upon occurrence of the decommissioning event, remote computing device 110 then sends a copy of function i to computing device A. Computing device A receives the copy of function i, and may save the received copy of function i on a local storage medium or device within computing device A, or at any other suitable location. The code map may then be updated with a location of the copy of the factored function. In this way, the remote dependency of computing device A on remote computing device 110 to execute function i may be removed, so that function i may be executed locally to computing device A, or at any other suitable location that avoids consuming the computing resources of remote computing device 110.

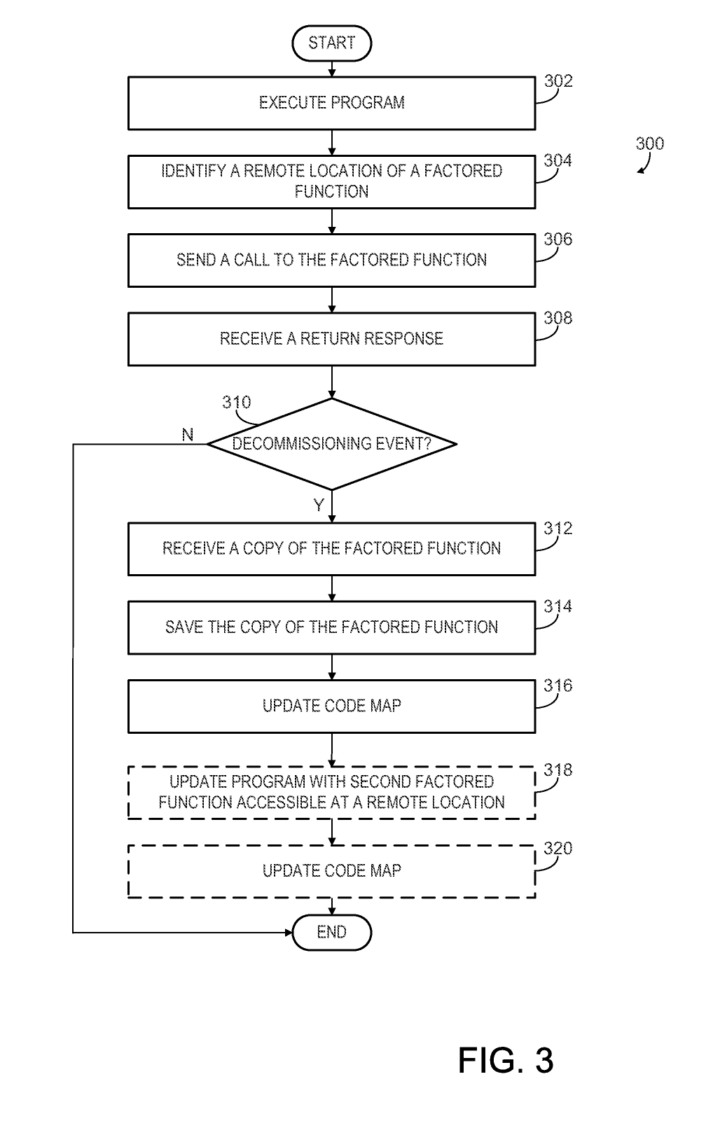

FIG. 3 shows an example embodiment of a method 300 for decommissioning factored code on a computing device. At 302, method 300 includes executing a program on the computing device. The program may be executed on a client device, including but not limited to a personal computer, mobile device, server, notepad computer, notebook computer, video game console, television, etc.

At 304, method 300 includes identifying a remote location of a factored function, e.g., function i shown in FIG. 1, via a code map while executing the program. As described above, the code map indicates the location of the code to be run by the program. The code map may be a library such as a manifest file or xml document which includes location information of the functions called by the program and which may be dynamically updated during program execution and decommissioning, or may take any other suitable form.

At 306, method 300 includes sending a call to the factored function. For example, as shown in FIG. 1, computing device A may send a call to function i on remote computing device 110, and remote computing device 110 may receive the call to factored function i. At 308, method 300 includes receiving a return response if the program that sent the call is an authorized copy of the program. For example, as shown in FIG. 1 computing device A may receive a return response from remote computing device 110 and remote computing device 110 may send a return response to computing device A. It will be understood that no return, or a different return, may be sent if the requesting program is an unauthorized copy of the program.

At 310, method 300 includes detecting the occurrence of a decommissioning event. The decommissioning event may take any suitable form. For example, the decommissioning event may correspond to the occurrence of a threshold event, such as a count threshold or a time threshold. In other embodiments, the decommissioning event may be initiated by a publisher of the program based on any suitable factors. For example, a publisher of the program may decide to decommission the program once the program has recovered profits expected from an initial investment, when operational costs associated with maintaining the program in factored form exceed profits expected from the published program, etc. Upon detecting a decommissioning event at 310, method 300 comprises receiving a copy of the factored function at 312.

When decommissioning a factored program, the factored program may be running, and thus at times may be executing the factored functions. Thus, in some embodiments, a program may be progressively decommissioned so that execution of the program is not affected or interrupted during the decommissioning. For example, a progressive download of a remotely-located function may be interrupted when the factored function is in use by the program, and then resumed when the factored function is not in use by the program. As such, in some embodiments, receiving a copy of the factored function at the client may comprise receiving at least a portion of the copy when the factored function is not in use by the program so that execution of the program is not affected by decommissioning operations. Likewise, decommissioning may proceed through various interruptions, such as interruptions in connectivity.

In some examples, following a detection of an occurrence of a decommissioning event, the code for a remotely-located function may be downloaded from the remote server to the client device so that the function can execute locally with all the overhead in execution rather than integrating the function into the running executable during a download. In this example, the decommissioning could be performed via a change of the executable and a link to a dll received from the remote server as a decommissioning product, for example.

Further, if a plurality of remotely-located functions are downloaded to the client during the decommissioning process, downloads of the remotely-located functions may be prioritized based on which functions are in use by the program. For example, if a first remotely-located function downloaded to the client is needed by the program, then the download of the first remotely-located function may be interrupted and a download of a second remotely-located function not in use by the program may be initiated. Once the first remotely-located function is no longer in use by the program, the download of the first remotely-located function may then continue where it left off before the interruption. Tracking what functions are in use by the program may be performed in a variety of ways. For example, the code map may be employed together with program run-time information to determine which functions are in use by the program. Further, when decommissioning multiple functions, downloads of the functions may be staggered in order to reduce deadlocks during the downloads.

During the progressive download of remotely-located functions during decommissioning, the code map may be dynamically updated to generate a function location and dependency map so that the program may continue to run during the downloads.

At 314, method 300 includes saving a copy of the factored function. For example, as shown in FIG. 2, a copy of function i may be saved on computing device A. In some examples, the downloaded function may include various digital rights management protections so that the downloaded function is still at least partially protected from piracy following decommissioning.

At 316, method 300 includes updating the code map with a location of the copy of the factored function. In this way, the program, which looks to the code map for function location information, may execute the downloaded function locally.

At times, a publisher of the program may desire to update the program, and to provide the update as factored code that is stored on a remote computing device to protect the new features of the program. Thus, at 318, method 300 optionally includes updating the program with a second factored function accessible at a remote location. Then, remote computing device 110 may execute the second factored function in response to a call to the function, and send a second return response to the client.

At 320, method 300 includes updating tire code map to identify the remote location of the second factored function so that the program is updated with the new functionality. Further, in some examples, the code map may include an indicator of a version of the program that is executing. The code map also may include information such as which remotely-located functions have been decommissioned and any new functionality or updates.

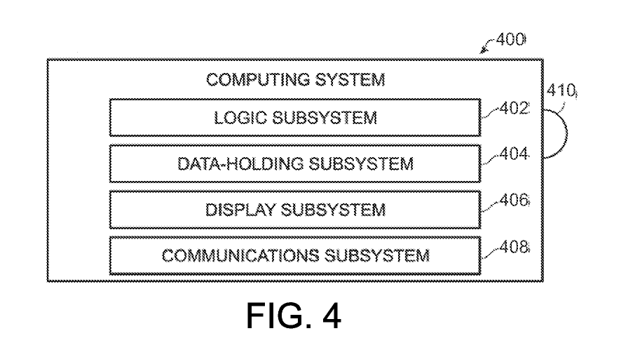

FIG. 4 schematically shows a nonlimiting computing system 400 that may perform one or more of the above described methods and processes. Computing system 400 may represent any of computing device A 102, computing device B 106, and remote computing device 110 of FIG. 1.

Computing system 400 is shown in simplified form. It is to be understood that virtually any computer architecture may be used without departing from the scope of this disclosure. In different embodiments, computing system 400 may take the form of a mainframe computer, server computer, desktop computer, laptop computer, tablet computer, home entertainment computer, network computing device, mobile computing device, mobile communication device, gaming device, etc.

Computing system 400 includes a logic subsystem 402 and a data holding subsystem 404. Computing system 400 may optionally include a display subsystem 406, communication subsystem 408, and/or other components not shown in FIG. 4. Computing system 400 may also optionally include user input devices such as keyboards, mice, game controllers, cameras, microphones, and/or touch screens, for example.

Logic subsystem 402 may include one or more physical devices configured to execute one or more instructions. For example, the logic subsystem 402 may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

Logic subsystem 402 may include one or more processors that are configured to execute software instructions. Additionally or alternatively, logic subsystem 402 may include one or more hardware or firmware logic machines configured to execute hardware or firmware instructions. Processors of logic subsystem 402 may be single core or multicore, and the programs executed thereon may be configured for parallel or distributed processing. The logic subsystem may optionally include individual components that are distributed throughout two or more devices, which may be remotely located and/or configured for coordinated processing. One or more aspects of logic subsystem 402 may be virtualized and executed by remotely accessible networked computing devices configured in a cloud computing configuration.

Data-holding subsystem 404 may include one or more physical, non transitory, devices configured to hold data and/or instructions executable by logic subsystem 402 to implement the herein described methods and processes. When such methods and processes are implemented, the state of data-holding subsystem 404 may be transformed (e.g., to hold different data).

Data-holding subsystem 404 may include removable media and/or built-in devices. Data-holding subsystem 404 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 404 may include devices with one or more of the following characteristics: volatile, nonvolatile, dynamic, static, read/Write, read-only, random access, sequential access, location addressable, file addressable, and content addressable. In some embodiments, logic subsystem 402 and data-holding subsystem 404 may be integrated into one or more common devices, such as an application specific integrated circuit or a system on a chip.

FIG. 4 also shows an aspect of the data-holding subsystem in the form of removable computer-readable storage media 410, which may be used to store and/or transfer data and/or instructions executable to implement the herein described methods and processes. Removable computer-readable storage media 410 may take the form of CDs, DVDs, HD-DVDs, Blu-Ray Discs, EEPROMs, and/or floppy disks, among others.

The term “program” may be used to describe an aspect of computing system 400 that is implemented to perform one or more particular functions. In some cases, such a program may be instantiated via logic subsystem 402 executing instructions held by data-holding subsystem 404 It is to be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The term “program” and “engine” is meant to encompass individual or groups of executable files, data files, libraries, drivers, scripts, database records, etc.

Display subsystem 406 may be used to present a visual representation of data held by data-holding subsystem 404. As the herein described methods and processes change the data held by the data-holding subsystem, and thus transform the state of the data-holding subsystem, the state of display subsystem 406 may likewise be transformed to visually represent changes in the underlying data. Display subsystem 406 may include one or more display devices utilizing virtually any type of technology. Such display devices may be combined with logic subsystem 402 and/or data-holding subsystem 404 in a shared enclosure, or such display devices may be peripheral display devices.

Communication subsystem 408 may be configured to communicatively couple computing system 400 with one or more other computing devices. Communication subsystem 408 may include wired and/or wireless communication devices compatible with one or more different communication protocols. As nonlimiting examples, the communication subsystem may be configured for communication via a wireless telephone network, a wireless local area network, a wired local area network, a wireless wide area network, a wired wide area network, etc. In some embodiments, the communication subsystem may allow computing system 400 to send and/or receive messages to and/or from other devices via a network such as the Internet.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method of operating a computing device, the method comprising:
executing a program on the computing device;
while executing the program, identifying a remote location of a factored function via a code map;
sending a call to the factored function and receiving a return response;
upon occurrence of a decommissioning event, receiving a copy of the factored function;
saving the copy of the factored function; and
updating the code map with a location of the copy of the factored function.

2. The method of claim 1, wherein receiving a copy of the factored function comprises receiving at least a portion of the copy when the factored function is not in use by the program.

3. The method of claim 2, further comprising interrupting receiving the copy of the factored function when the factored function is in use by the program, and resuming receiving the copy of the factored function when the factored function is not in use by the program.

4. The method of claim 1, wherein the code map is a manifest file.

5. The method of claim 1, wherein the decommissioning event occurs following an event count threshold.

6. The method of claim 1, wherein the decommissioning event occurs after a time threshold.

7. The method of claim 1, wherein the factored function is a first factored function, and the method further comprises updating the program with a second factored function in addition to the first factored function, the second factored function accessible at a remote location, and updating the code map to identify the remote location of the second factored function.

8. The method of claim 7, wherein the code map includes an indicator of a version of the program that is executing.

9. A method for decommissioning factored code of a program on a computing device, the method composing:
receiving a call to a factored function from a client;
executing the factored function and sending a return response to the client;
detecting an occurrence of a decommissioning event; and
sending a copy of the factored function to the client.

10. The method of claim 9, wherein sending a copy of the factored function to the client comprises sending at least a portion of the copy when the factored function is not in use by the program.

11. The method of claim 9, further comprising interrupting sending a copy of the factored function to the client when the factored function is in use by the program, and resuming sending a copy of the factored function to the client when the factored function is not in use by the program.

12. The method of claim 9, wherein the decommissioning event occurs following an event count threshold.

13. The method of claim 9, wherein the decommissioning event occurs after a time threshold.

14. The method of claim 9, wherein the factored function is a first factored function, and the method further comprises updating the program with a second factored function in addition to the first factored function, the second factored function, and executing the second factored function and sending a second return response to the client

15. A computing device, comprising:
a logic subsystem; and
a data holding subsystem comprising machine-readable instructions stored thereon that are executable by the logic subsystem to:
execute a program;
while executing the program, identify a remote location of a factored function via a code map;
send a call to the factored function and receiving a return response;
upon occurrence of a decommissioning event, receive a copy of the factored function;
save the copy of the factored function; and
update the code map with a location of the copy of the factored function.

16. The computing device of claim 15, wherein receiving a copy of the factored function comprises receiving at least a portion of the copy when the factored function is not in use by the program.

17. The computing device of claim 16, wherein the computing system is further configured to interrupt receiving the copy of the factored function when the factored function is in use by the program, and resume receiving the copy of the factored function when the factored function is not in use by the program.

18. The computing device of claim 15, wherein the factored function is a first factored function, and the computing system is further configured to update the program with a second factored function accessible at a remote location, and update the code map to identify the remote location of the second factored function.

19. The computing device of claim 15, wherein the code map includes an indicator of a version of the program that is executing.

20. The computing device of claim 15, wherein the decommissioning event occurs following one or more of an event count threshold and a time threshold.
